(19) United States
(12) Patent Application Publication
(10) Pub. No.: US 2007/0211385 A1
(43) Pub. Date: Sep. 13, 2007

(54) MAGNETIC HEAD DEVICE CAPABLE OF STABILIZING THE FLOATING DISTANCE BETWEEN A MAGNETIC FUNCTIONAL UNIT AND THE SURFACE OF A RECORDING MEDIUM

(75) Inventors: Yasuyuki Kondo, Niigata-ken (JP); Hirohisa Ishihara, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/682,108

(22) Filed: Mar. 5, 2007

(30) Foreign Application Priority Data
Mar. 7, 2006 (JP) 2006-061459

(51) Int. Cl. G11B 5/60

(52) U.S. Cl. 360/236.1; 360/236.3

(57) ABSTRACT

A magnetic head device floats above a surface of a rotating recording medium due to airflow. A front positive-pressure surface is formed in the leading side of an opposed surface of a slider, and a rear positive-pressure surface is formed in the trailing side. A front edge portion of the rear positive-pressure surface has a shape recessed toward the trailing side, and a concave portion is formed from the front edge portion toward the magnetic functional unit. Airflow flowing between the slider and the recording medium is concentrated in the rear of the concave portion. When the magnetic functional unit emits heat and thus a portion projects toward the recording medium, a decrease in the floating distance of the magnetic functional unit can be counteracted by the local positive pressure of the airflow concentrated locally.

This application claims the benefit of Japanese Patent application No. 2006-061459 filed Mar. 7, 2006, which is hereby incorporated by reference.

### TECHNICAL FIELD

A magnetic head device provided with a magnetic functional unit in a slider that faces a magnetic recording medium, such as a hard disk, and more particularly, to a magnetic head device capable of stabilizing a floating distance of a magnetic functional unit.

### BACKGROUND

A magnetic head device writes a magnetic signal on a magnetic recording medium such as a hard disk, and reads the magnetic signal written on the magnetic recording medium. The apparatus has a slider that faces the magnetic recording medium and a magnetic functional unit on a trailing end portion of the slider. The magnetic functional unit has a reproduction functional section using MR effect or GMR effect and has a recording functional section in which a yoke and a coil for a magnetic material are formed of a thin film.

The slider of the magnetic head device is pressed by an elastic member, such as a load beam, onto the surface of the magnetic recording medium. The slier rises by an airflow flowing between the surface and the slider when the magnetic recording medium rotates. Consequently, a predetermined floating amount or floating distance from the magnetic functional unit and the surface of the recording medium is set.

In this type of magnetic head device, a positive-pressure surface generates a floating pressure by the airflow or a negative-pressure generating surface recessed from the positive-pressure surface is formed. The slider properly rises on the surface of the recording medium, and the floating distance can be stabilized due to a balance between a floating force applied to the positive-pressure surface and a sucking force generated on the negative-pressure generating surface so as to suck the recording medium.

In order to accomplish improvement of a magnetic recording density for the magnetic recording medium in high-speed recording and reproduction of a magnetic signal, a floating distance of the magnetic functional unit from the recording medium is set as small as possible.

In Patent Document 1 below, there is disclosed a magnetic head device for decreasing a floating distance from a recording medium, for stabilizing a variation in floating distance during a seek operation of a moving magnetic head between an inner periphery and outer periphery of the recording medium, and particularly, for suppressing a variation in yaw angle.

In this magnetic head device, a front dynamic pressure generating portion and a rear dynamic pressure generating portion are provided, and a floating force operates to the front dynamic generating portion, and a negative pressure is generated to the rear dynamic generating portion, and a deeply recessed portion in which the floating force is not applied and the negative pressure is not generated, is formed in the central portion thereof The magnetic head device stabilizes a dynamic posture of the head mainly by the floating force of the front dynamic pressure generating portion and the negative force of the rear dynamic pressure generating portion.

JP-A-10-283622 (U.S. Pat. No, 6,021,020) is an example of the related art.

In this type of the magnetic head device, since a recording current is provided to a coil of a magnetic recording unit disposed in a trailing end portion of the slider when a recording operation is executed, the magnetic recording unit emits heat and thus a portion in which the magnetic recording unit is disposed and the vicinity thereof is locally expanded due to heating. Accordingly, PTP (Pole Tip Protrusion) phenomenon occurs and the slider is protruded toward the recording medium.

In the known magnetic head device, a floating distance from the recording medium of the magnetic recording unit is set to a minimum, for example, a floating distance of 10 to 20 nm, to increase a recording speed and improve a recording density. Meanwhile, when the slider is locally projected toward the recording medium by about 5 nm due to the PTP phenomenon, a distance between the magnetic recording unit and the recording medium becomes less than 5 nm, increasing the likelihood that magnetic functional unit contacts the surface of the recording medium during a writing operation, and thus, the magnetic functional unit or the surface of the recording medium may be easily damaged.

Particularly, when the magnetic head device is used under a high-temperature condition, the temperature of the magnetic functional unit increases due to the emitted heat, the projecting amount increases by the PTP phenomenon, and thus, the magnetic functional unit or the surface of the recording medium may be easily damaged.

However, as described in Patent Document 1, the related magnetic head is designed for merely lower-floating of the slider. Accordingly, when a distance between the magnetic recording unit and the recording medium decreases due to the PTP phenomenon, the decreasing value may not be compensated.

### SUMMARY

In order to accomplish the abovementioned object, according to an aspect of the invention, there is provided a magnetic head device capable of counteracting a decrease in distance between a magnetic recording unit and a recording medium even when the magnetic recording unit emits heat.

According to a first aspect of the invention, there is provided a magnetic head device including a slider that has an opposed surface facing a recording medium, and a pressing surface on which a pressing force is applied toward the recording medium; and a magnetic functional unit which is disposed in the trailing side of the slider so as to magnetically record data. A front positive-pressure surface is located in a leading side, and a rear positive-pressure surface is located in a trailing side, and are disposed in the opposed surface of the slider. The magnetic functional unit is located in the rear positive-pressure surface or at a position closer to the trailing side than the rear positive-pressure surface and close to the rear edge portion of the rear positive pressure surface. Projecting portions extend to the leading side are formed on both left and right sides of the rear positive-pressure surface. The front edge portion of the rear positive-pressure surface has a shape recessed toward the trailing side, and a concave portion is formed from the front edge portion toward the magnetic functional unit.

In the magnetic head device according to the first aspect of the invention, since the front edge portion of the rear positive-pressure surface has a recessed shape, air flowing on the surface of the recording medium due to a rotation of the recording medium is concentrated in the recessed shape and is provided to the rear positive-pressure surface. Accordingly, the positive pressure (floating force) applied to the rear positive-pressure surface is constantly stabilized and thus the floating posture of the slider is easily stabilized. In addition, in the recessed shape of the rear positive-pressure surface, since the concave portion is formed from the front edge portion toward the magnetic functional unit, the air concentrated in the recessed portion is locally provided to the rear positive-pressure surface in the region that has the magnetic functional unit. Since the air is provided to a portion in which the magnetic functional unit in the trailing side, the positive pressure in this portion constantly locally increases. Accordingly, when a portion of the magnetic functional unit projects toward the recording medium due to the PTP phenomenon, the locally high positive pressure is applied to the projected portion and thus the floating force separating the projected portion from the recording medium is generated due to the positive pressure. Accordingly, a decrease in distance between the projected portion and the recording medium can be counteracted.

According to a second aspect of the invention, there is provided a magnetic head device including a slider that has an opposed surface facing a recording medium and a pressing surface on which a pressing force is applied toward the recording medium. A magnetic functional unit is disposed in a trailing side of the slider so as to magnetically record data. A front positive-pressure surface located in a leading side and a rear positive-pressure surface located in the trailing side are disposed in the opposed surface of the slider, wherein the magnetic functional unit is located in the rear positive-pressure surface or at a position closer to the trailing side than the rear positive-pressure surface and close to the rear edge portion of the rear positive pressure surface. A concave portion is formed from the leading front edge portion of the rear positive-pressure surface toward the magnetic functional unit. A pair of guide ribs extend from the front edge portion to the leading side and are formed on both sides of the concave portion. An air guiding passage guides air into the concave portion and is formed between both guide ribs.

In the second aspect of the invention, both guide ribs are continuously formed from the front positive-pressure surface to the rear positive-pressure surface, and the air guiding passage is open in the front edge portion of the front positive-pressure surface close to the leading side. However, the front ends of the guide ribs may be located in the rear of the rear edge portion of the front positive-pressure surface.

In the second aspect of the invention, since air flowing on the opposed surface of the slider is guided into the air guiding passage and is provided to the concave portion, the air is easily concentrated in the region where the magnetic functional unit is disposed. For this reason, a constantly high positive pressure is applied to the portion projected due to the emitted heat and thus a decrease in floating distance between the projected portion and the surface of the recording medium is easily counteracted.

The width of the concave portion may become gradually smaller toward the trailing side.

In the configuration, the width of the concave portion becomes gradually smaller toward the magnetic functional unit, and the airflow concentrated in the concave portion is further concentrated and provided to a portion that has the magnetic functional unit, and thus a high positive pressure can be constantly applied to the portion projected due to the PTP phenomenon.

The width of the front positive-pressure surface may be in the range of 30% to 100% of the width of the front positive-pressure surface and the area of the rear positive-pressure surface may be in the ranged of 20% to 80% of that of the front positive-pressure surface.

Since the area of the rear positive-pressure surface is sufficiently wide, a change in floating force applied to the rear positive-pressure surface decreases and thus a floating distance between the trailing end portion of the slider and the recording medium can be stabilized.

When an imaginary line extending parallel to the side surface of the slider through the center of the magnetic functional unit is used as a reference line, a central line equally dividing the width of the concave portion into two portions may be matched with the reference line.

When the center line is matched with the reference line, the air concentrated in the concave portion is intensively provided to the portion having the magnetic functional unit and the local positive pressure can be given to a proper position of the portion projecting due to the PTP phenomenon.

In the invention, the slider in the trailing side is locally projected due to the heat emitted by a recording operation of the magnetic functional unit. The local projection can be counteracted to avoid contact between the magnetic functional unit and the recording medium,

### DRAWING

FIG. 1 is a perspective view illustrating a magnetic head device with an opposed surface directed upward according to a first embodiment of the invention.

FIG. 2 is a plan view illustrating the magnetic head device of the first embodiment as viewed from the opposed surface.

FIG. 3 is a plan view illustrating a magnetic head device according to a second embodiment of the invention as viewed from an opposed surface.

FIG. 4 is a plan view illustrating a magnetic head device of Comparative Example 1 as viewed from an opposed surface.

FIG. 5 is plan view illustrating a magnetic head device of Comparative Example 2 as viewed from an opposed surface.

FIG. 6 is a three-dimensional diagram illustrating a result of a simulation in an operating state of a positive pressure and a negative pressure in an opposed surface of a slider of Example 1.

FIG. 7 is a three-dimensional diagram illustrating a result of a simulation in an operating state of a positive pressure and a negative pressure in an opposed surface of a slider of Example 2.

FIG. 8 is a three-dimensional diagram illustrating a result of a simulation in an operating state of a positive pressure and a negative pressure in an opposed surface of a slider of Comparative Example 1.

FIG. 9 is a three-dimensional diagram illustrating a result of a simulation in an operating state of a positive pressure and a negative pressure in an opposed surface of a slider of Comparative Example 2.

FIG. 10 is a plan view illustrating an opposed position between a recording medium and a magnetic head.

FIG. 11 is a side view illustrating a supporter supporting a magnetic head device.

### DETAILED DESCRIPTION

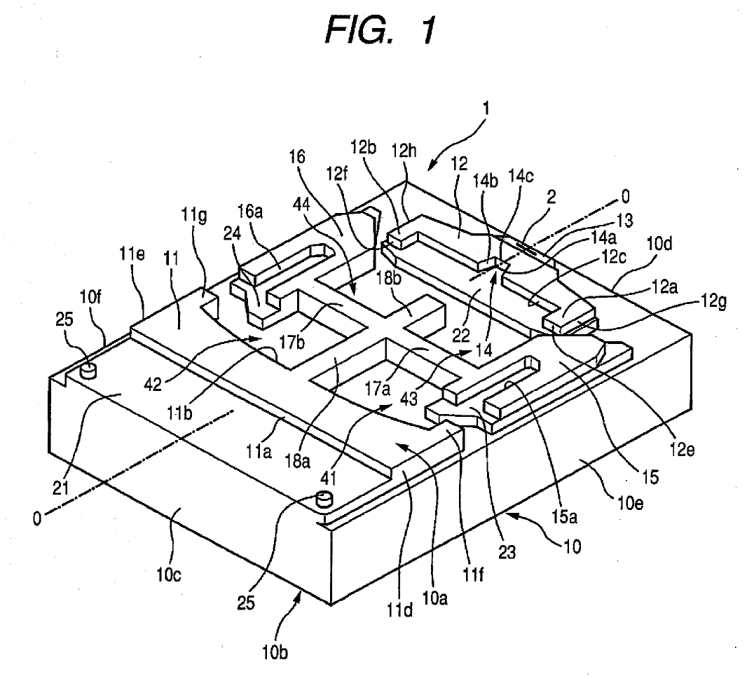

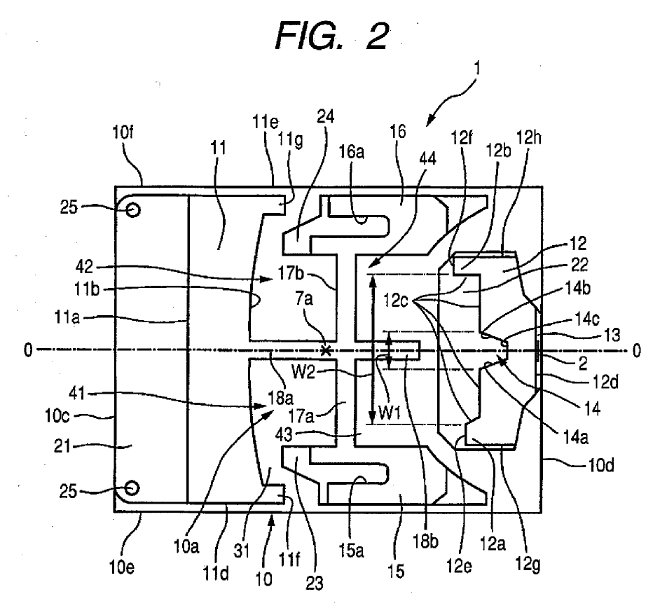

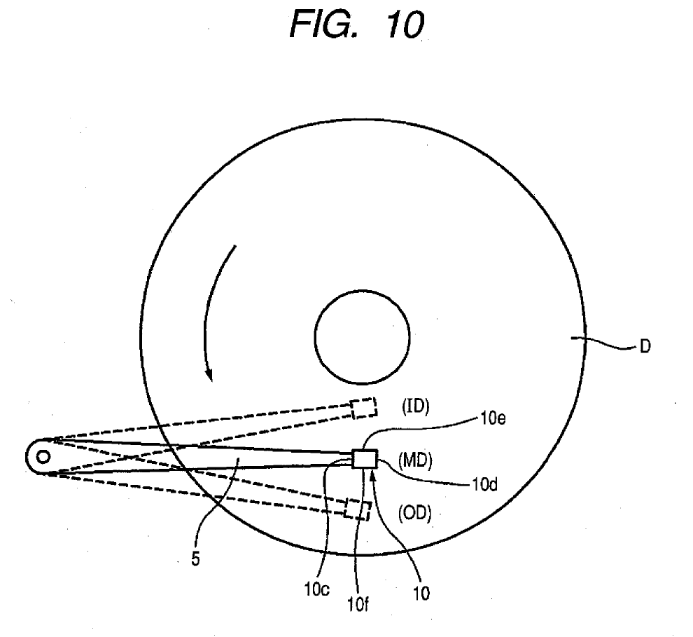

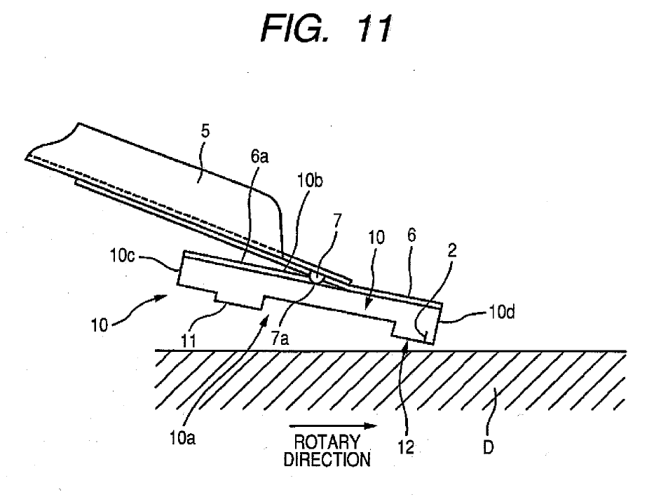

FIG. 1 is a perspective view illustrating a magnetic head device with an opposed surface directed upward according to a first embodiment of the invention. FIG. 2 is a plan view illustrating the magnetic head device of the first embodiment as viewed from the opposed surface. FIG. 10 is a plan view illustrating an opposed position between a recording medium and a magnetic head. FIG. 11 is a side view illustrating a supporter supporting a magnetic head device.

A magnetic head 1 of the first embodiment as shown in FIGS. 1 and 2, has a regular hexahedron-shaped slider 10 formed of alumina titanium carbide, and a magnetic functional unit 2 mounted on the slider 10.

The magnetic functional unit 2 has a reproduction functional section that reads a magnetic signal written in a magnetic recording medium D by using a magnetoresistanee effect (MR effect), a giant magnetoresistance effect (GMR effect), or a tunnel magnetoresistance effect (TMR effect). The magnetic functional unit 2 also includes a recording functional section in which a thin film is formed of a yoke of a magnetic material or a coil of a conductive material to record a magnetic signal on the recording medium D.

The slider 10 has an opposed surface 10a facing the recording medium, and a pressing surface 10b facing the opposite side of the opposed surface 10a. The slider 10 has a leading end surface 10c that faces an inflow side of airflow generated on the surface of the recording medium D, and has a trailing end surface 10d in which air flows out. The magnetic functional unit 2 is disposed in the trailing end surface. The slider 10, as shown in FIG. 10, has a inner peripheral (ID) surface 10e facing the rotary center of recording medium D, and a outer peripheral (OD) surface I Of facing the outer periphery the recording medium D.

In the specification, a direction toward the leading end surface 10c is referred to as a front or an end portion toward the leading end surface 10c, an edge portion is referred to as a front end or a front edge portion, and a direction toward the trailing end surface 10d is referred to as a rear or an end portion toward the trailing end surface 10d, and an edge portion is referred to as a rear end or a rear edge portion. Further, a direction parallel to the leading end surface 10c and the trailing end surface 10d is call a left and right direction, a direction toward the inner peripheral surface 10e is called a left, and a direction toward the outer peripheral surface 10f is called a right.

In FIGS. 1 and 2, an imaginary central line equally divides the leading end surface 10c and the trailing end surface 10d into two portions, and extends in the front and rear direction, is defined as reference line O-O. The center of the magnetic functional unit 2 is positioned on the reference line O-O.

As shown in FIG. 11, the pressing surface 10b of the slider 10 constituting the magnetic head device 1 is supported by the supporter, A load beam 5, which is an elastic support member is provided in the supporter. An elastic deforming portion is provided in the base of the load beam 5 and a pressing force (loading pressure) toward the recording medium D is applied to the slider 10 by the elastic force of the elastic deforming portion. A flexure 6 which is thinner than the load beam 5 and which is formed of an elastic plate having a spring property, is fixed to the front portion of the load beam 5, and the pressing surface 10b of the slider 10 is adhered and fixed to a support piece 6a flexed by the flexure 6.

A pivot 7 projecting downwardly is integrally formed at the front portion of the load beam 5, and the pivot 7 contacts the pressing surface 10b of the slider 10 or the support piece 6a. An elastic pressing force generated by the load beam 5 is concentrated at the contact point 7a at which the pivot 7 and the pressing surface 10b of the slider 10 contact. The support piece 6a of the flexure 6 is deformable in each direction, and the position of the slider 10 fixed to the support piece 6a is modifiable from the contact point 7a with the pivot 7. The main direction of the modification in the posture is a pitch direction in which the reference line O-O inclines and a rolling direction in which the slider 10 inclines left and right from the periphery of the reference line O-O.

In FIG. 2, the contact point 7a of the pivot 7 and the slider 10 is illustrated the opposed surface 10a of the slider 10. The contact potion 7a is located on the reference line O-O and is located at the substantially central point between the leading end surface 10c and the trailing end surface 10d.

As shown in FIGS. 1 and 2, in the opposed surface 10a of the slider 10, a front positive-pressure surface 11 is formed in the front of the contact point 7a, is in the rear of the contact point 7a. A rear positive-pressure surface 12 is formed in the position close to the trailing end surface 10d. The front positive-pressure surface 11 and the rear positive-pressure surface 12 are the closest surfaces (the farthest surface from the pressing surface 10b) to the recording medium in the opposed surface 10a of the slider 10.

In the specification, a plane includes a curved surface in which a radius of curvature is very large, as well as an ideal plane in which a radius of curvature is infinite. In this embodiment, the front positive-pressure surface 11 and the rear positive-pressure surface 12 are on the same plane. However, the front positive-pressure surface 11 and the rear positive-pressure surface 12 may be not on the same plane, for example, the front positive pressure 11 may be closer to the recording medium than the rear positive-pressure surface 12.

The front positive-pressure surface 11 has a front edge portion 11a, a rear edge portion 11b, a left edge portion 11d, and a right edge portion 11e. The front edge portion 11a is a straight-line shape perpendicular to the reference line O-O, and the portion perpendicular to the reference line O-O of the rear edge portion 11b is a projecting curved-line shape which becomes closer to the leading end surface 10c.

The left edge portion 11d is matched with the inner peripheral surface 10e of the slider 10 or is located in the vicinity thereof, and the right edge portion 11e is matched with the outer peripheral surface 10f of the slider 10 or is located in the vicinity thereof In addition, a part of the left edge portion 11d extends rearward of the rear edge portion 11b and a rear extending portion 11f extending rearward of the rear edge portion 11b is formed at the left end portion of the front positive-pressure surface 11. A part of the right edge portion 11e extends rearward of the rear edge portion 11b and the rear extending portion 11g extending rearward of the rear edge portion 11b is formed at the right end portion of the front positive-pressure surface 11.

A rear edge portion 12d of the rear positive-pressure surface 12 is located in the position close to the trailing end surface 10d and a rear installation surface 13 slightly lower (slightly apart from the recording medium) than the rear positive-pressure surface 12 is formed in the rear of the rear edge portion 12d. The magnetic functional unit 2 is located on the rear installation surface 13, and the magnetic functional unit 2 is disposed close to the rear edge portion 12d of the rear positive-pressure surface 12. The magnetic functional unit 2 is exposed on the rear installation surface 13 or is disposed slightly apart from the recording medium than the rear installation surface 13. The magnetic functional unit 2 may be located in the rear positive-pressure surface 12 and may be disposed close to the rear edge portion 12d.

On the rear positive-pressure surface 12, a left projecting portion 12a in which the left end portion thereof extends frontward is formed, and a right projecting portion 12b in which the right end portion thereof extends frontward is formed. Consequently, a front edge portion 12c of the rear positive-pressure surface 12 is has a recessed shape toward the trailing end surface 10d.

A concave portion 14 which is concave from the front edge portion 12c rearward is formed in the front end portion of the rear positive-pressure surface 12. A facing space between a left inner wall 14a and right inner wall 14b of the concave portion 14 becomes gradually smaller rearward. A rear inner wall 1 4c of the concave portion 14 is a plane perpendicular to the reference line O-O, and the rear inner wall 14c is located in the rear of the front edge portion 12c. Since a space between the rear inner wall 14c and the rear edge portion 12d is provided, a part of the rear positive-pressure surface 12 exists in the rear of the concave portion 14. The rear inner wall 14c may be a concave curved surface swelling rearwardly.

In the rear of the concave portion 14, due to the concave portion 14, the area (length of the front and rear) of the rear positive-pressure surface 12 becomes locally smaller than the other portion in the vicinity of the reference line O-O. Accordingly, since airflow terminated in the concave portion 14 is concentrated on the small area portion, high pressure can be locally generated in the small area portion.

As shown in FIG. 2, an opening width of the concave portion 14 formed by opening the front edge portion 12c is defined as W1, and an opening width of the recessed shape of the front edge portion 12c is defined as W2. The opening width W1 is preferably ⅓ of the opening width W2, and more preferably, ¼ thereof or less, The lower limit is about 1/10.

The front edge portion 12c of the rear positive-pressure surface 12, as shown in FIG. 2, is defined as the front edge portion 12e of the left projecting portion 12a, the front edge portion 12f of the right projecting portion 12b, and the whole front edge portion except the concave portion 14. In this embodiment, the front edge portion 12c is recessed rearward to be a substantially rectangular concave in shape, but the front edge portion 12c may be recessed rearward to be a concave curved-line shape.

A left edge portion 12g and the tight edge portion 12h of the rear positive-pressure surface 12 are spaced apart from the reference line O-O by the same distance. The width of the rear positive-pressure surface 12 is in the range of 30% to 100% of that of the front positive-pressure surface 11, and preferably is 40% or more. Herein, the width of the rear positive-pressure surface 12 is defined as a facing distance between the left edge portion 12g and the right edge portion 12h , and the width of the front positive-pressure surface 11 is defined as a facing distance between the left edge portion 11d and the right edge portion 11e. Further, the area of the rear positive-pressure surface 12 is preferably in the range of 20% to 80% of the area of the front positive-pressure surface 11.

When the width and area of the rear positive-pressure surface 12 is in the above-mentioned range, a stable positive pressure can be applied to the rear positive-pressure surface 12 by the airflow which flows between the rear positive-pressure surface 12 and the surface of the recording medium D. The floating position of the slider 10 can be stabilized on the recording medium D by the positive pressure applied to the front positive-pressure surface 11 and the positive pressure applied to the rear positive-pressure surface 12.

A left positive-pressure surface 15 and a right positive-pressure surface 16 are provided in the rear of the front positive-pressure surface 11 and in the front of the rear positive-pressure surface 12. The left positive-pressure surface 15 and the right positive-pressure surface 16 are spaced apart from the reference line O-O by the same distance. The left positive-pressure surface 15 and the right positive-pressure surface 16 are on the same plane as the front positive-pressure surface 11. Further, the left positive-pressure surface 15 and the right positive-pressure surface 16 are on the same plane as the rear positive-pressure surface 12.

An air guiding passage 15a opening frontward is formed in the left positive-pressure surface 15, and an air guiding passage 1 6a opening frontward is-also formed in the left positive-pressure surface 16.

Transverse ribs 17a, 17b linking the left positive-pressure surface 15 to the right positive-pressure surface 16 are formed in the slight rear of the contact point 7a. The surfaces of the transverse ribs 17a, 17b are on the same plane as the left positive-pressure surface 15 and right positive-pressure surface 16. The transverse ribs 17a, 17b are formed on a straight line in the direction perpendicular to the reference line O-O. Further, longitudinal ribs 18a, 18b are formed on the reference line O-O. The longitudinal rib 18a links between the rear edge portion 11b of the front positive-pressure surface 11 and the transverse ribs 17a, 17b. The longitudinal rib 18b projects in the rear of the transverse ribs 17a, 17b. The surface of the longitudinal ribs 18a, 18b are on the same plane as the transverse ribs 17a, 17b.

A front step surface 21 is formed between the front edge portion 11a of the front positive-pressure surface 11 and the leading end surface 10c. A rear step surface 22 is formed in the front of the front edge portion 12c of the rear positive-pressure surface 12 and in the front of the concave portion 14. The front end of the rear step surface 22 is located in the rear of the rear end of the longitudinal rib 18b. A left step surface 23 is formed in the front of the left positive-pressure surface 15 and in the air guiding passage 15a. A right step surface 24 is formed in the front of the left positive-pressure surface 16 and in the air guiding passage 16a. The front step surface 21, the rear step surface 22, the left step surface 23, and the right step surface 24 are on the same plane each other. These surfaces are in a position (position close to the pressing surface 10b) slightly further apart from the recording medium than the front positive-pressure surface 11 or the rear positive-pressure surface 12.

In an angled portion in which the leading end surface 10c of the slider 10 is crossed to the side surface 10c, and an angled portion in which the leading end surface 10e is crossed to the side surface 10f, circular projections 25, 25 are formed on the front step surface 21. The projections 25, 25 are provided so that the angled portions of the slider 10 do not directly contact the recording medium D.

In the opposed surface 10a of the slider 10, a portion except the positive-pressure surfaces 11, 12, 15, 16, the transverse ribs 17a, 17b, the longitudinal ribs 18a, 18b, and the step surfaces 21, 22,23, 24 defines the bottom surface 31. The bottom surface 31 is a plane located in a side (side close to the pressing surface 10b) further apart from the recording medium than the step surface 21, 22, 23, 24.

As a result, a left front negative-pressure generating region 41 is formed in the rear of the rear edge portion 11b of the front positive-pressure surface 11 and between the rear extending portion 11f and the longitudinal rib 18a. A right front negative-pressure generating region 42 is formed in the rear of the rear edge portion 11b of the front positive-pressure surface 11 and between the rear extending portion 11g and the longitudinal rib 18a. The left front negative-pressure generating region 41 and the right front negative-pressure generating region 42 are located in the front of the contact point 7a. A left rear negative-pressure generating region 43 is formed in the rear of the transverse rib 17a and between the left positive-pressure surface 15 and the longitudinal rib 18b. A right rear negative-pressure generating region 44 is formed in the rear of the transverse rib 17b and between the right positive-pressure surface 16 and the longitudinal rib 18b.

A level difference between the positive-pressure surfaces 11, 12, 15, 16 and the step surface 21, 22, 23, 24, for example, is 0.3 μm or less and the lower limit is about 0.05 μm. A level difference between the positive-pressure surface 11, 12, 15, 16 and a level difference between the surface of the ribs 17a, 17b, 18a, 18b and the bottom surface 31 are preferably 2.5 μm or less to generate a proper negative pressure and the lower limit is about 0.5 μm.

When the recording medium D rotates with the opposed surface 10a of the magnetic head device 1 facing the recording medium D, an airflow (air bearing) flowing on the surface of the recording medium D enters from the leading end surface 10c of the slider 10 into the front step surface 21, and flows on the front positive-pressure surface 11. Since the airflow flows in the gap between the surface of the recording medium D and the front positive-pressure surface 11, a positive pressure is generated on the front positive-pressure surface 11, and a floating force is applied to the front positive-pressure surface 11. Thus, the leading end surface 10c becomes separated from the surface of the recording medium D. Further, the airflow flows rearward and is guided from the rear step surface 22 into the rear positive-pressure surface 12. Since the airflow flows in the gap between the surface of the recording medium D and the rear positive-pressure surface 12, a positive pressure is generated on the rear positive-pressure surface 12.

The front portion of the slider 10 floats due to the pressure generated on the front positive-pressure surface 11, and the rear portion of the slider 10 floats due to the pressure applied to the rear positive pressure 12. Accordingly, when the recording medium D rotates, as shown in FIG. 11, the leading end surface 10c is farther apart from the recording medium D than the trailing end surface 10d and the slider 10 floats in an inclined position of a predetermined pitch angle. The airflow flowing on the opposed surface 10a of the slider 10 is guided from the left step surface 23 into the left positive-pressure surface 15, and is guided from the right step surface 24 into the right positive-pressure surface 16, and the positive pressure is applied to the left positive-pressure surface 15 and the right positive-pressure surface 16. Thus, the rolling posture of the slider 10 in the floating posture is stabilized by the positive pressure.

Since the airflow passes through the rear edge portion 11b of the front positive-pressure surface 11 and right then an air density decreases, a negative pressure is generated in the left front negative-pressure generating region 41, and the right front negative-pressure generating region 42 and the negative pressure generates a vacuum force which attracts the opposed surface 10a of the slider 10 toward the surface of the recording medium D. Similarly, since the airflow passes through the transverse ribs 17a, 17b and right then an air density decreases, a negative pressure is generated in the left rear negative-pressure generating region 43 and the right rear negative-pressure generating region 44. A floating distance of the slider 10 from the surface of the recording medium D can be determined by the balance of the positive pressure generated in the positive-pressure surface 11, 12, 15, 16 and the negative pressure generated in the negative-pressure generating regions 41, 42, 43, 44.

Since the width of the rear positive-pressure surface 12 is 30% of that of the front positive-pressure surface 11, and the area of the rear positive-pressure surface 12 is 20% of that of the front positive-pressure surface 11, a relatively high positive pressure is generated on the rear positive-pressure surface. Particularly, the left projecting portion 12a and right projecting portion 12b is provided on both left and right sides of the rear positive-pressure surface 12. The front edge portion 12c of the rear positive-pressure surface 12 has a recessed shape, so the airflow flowing rearward the slider 10 is concentrated by the recessed shape and is given to the rear positive-pressure surface 12. For the reason, a stable positive pressure is applied to the rear positive-pressure surface 12.

In the slider 10, by the positive pressure uniformly applied to the rear positive-pressure surface 12, and the balance of negative pressure applied to the negative-pressure generating regions 41, 42, 43, 44, particularly, the balance between the positive pressure and the negative pressure applied to the left rear negative-pressure generating region 43 and the right rear negative-pressure generating region 44, a floating distance the magnetic functional unit 2 from the surface of the recording medium D is set to a minimum. The floating distance of the magnetic functional unit 2 from the surface of the recording medium D is set to be 30 nm or less, for example, 10 to 20 nm.

In addition, since the concave portion 14 is formed in the rear positive-pressure surface 12, the airflow is guided in the concave portion 14 and is concentrated on the reference line O-O of the rear positive-pressure surface 12. Particularly, since the front edge portion 12c of the rear positive-pressure surface 12 has a shape recessed rearwardly, the air concentrated in the recessed-shaped front edge portion 12c is guided into the concave portion 14, whereby the air can be concentrated in the vicinity of the reference line O-O of the rear positive-pressure surface 12. Since the distance between the left inner wall 14a and the right inner wall 14b of the concave portion 14 becomes gradually smaller rearward, the airflow is further concentrated on the reference line O-O of the rear positive-pressure surface 12.

When writing to the recording medium D, a current is applied to a coil provided in a magnetic recording unit of the magnetic functional unit 2. Accordingly, the magnetic recording unit emits heat, a portion which is the vicinity of the reference line O-O of the rear positive-pressure surface 12 and close to the magnetic functional unit 2, and which is close to the rear edge portion 12d. That portion thermally expands, and thus the portion projects toward the recording medium D (PTP phenomenon). The projecting amount by the PTP phenomenon is different according to the environmental temperature and the like, but the projecting amount may be about 5 nm when the environmental temperature is high.

However, the projection by the PTP phenomenon is generated on the reference line O-O and in the vicinity thereof In addition, in the rear positive-pressure surface 12, air is locally concentrated in the vicinity of the reference line O-O by the concave portion 14. Accordingly, when the rear positive-pressure surface 12 projects in the reference line O-O by the thermal expansion, the floating force tends to separate the projecting portion from the surface of the recording medium D by the airflow concentrated between the projecting portion and the surface of the recording medium D

When the heat emitted be the magnetic functional unit 2 is low and a part of the rear positive-pressure surface 12 does not project, by a balance of the local positive pressure generated by the concave portion 14, the whole positive pressure applied to the rear positive-pressure surface 12, the negative pressure generated in the negative-pressure generating region 41, 42, 43, 44, and particularly, the negative pressure generated in the left rear negative-pressure generating region 43 and the right rear negative-pressure generating region 44, the floating distance from the recording medium D of the magnetic functional unit 2, for example, is properly set to be in the range of 10 to 20 nm.

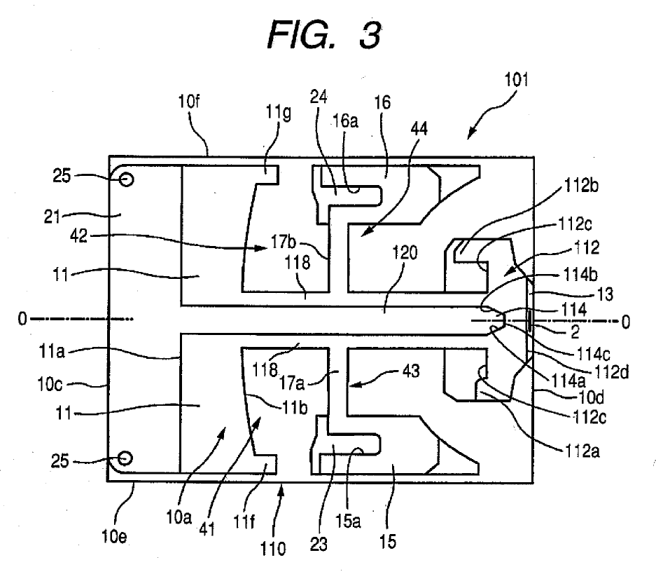

FIG. 3 is a plan view illustrating a magnetic head device 101 according to the second embodiment of the invention as viewing a slider 10 from an opposed surface 10a.

In the magnetic head device 101 shown in FIG. 3, the same reference numerals are given to equivalent structures of the magnetic head device 1 of the first embodiment and thus detail description thereof is be omitted.

In a slider 110 of the magnetic head device 101, a front positive-pressure surface 11, left positive-pressure surface 15, and right positive-pressure surface 16 are formed on an opposed surface 10a thereof. A transverse rib 17a linked to the left positive-pressure surface 15 and a transverse rib 17b linked to the right positive-pressure surface 16 are formed. A front step surface 21 is formed in the front of the front positive-pressure surface 11. A left step surface 23 is formed in the front of the left positive-pressure surface 15 and a right step surface 24 is formed in the front of the right positive-pressure surface 16.

As shown in FIG. 3, in the opposed surface 10a of the slider 110 and a rear positive-pressure surface 112 is provided in the trailing side. A rear edge portion 112d of the rear positive-pressure surface 112 is close to a trailing end portion 10d of the slider 110, and a magnetic functional unit 2 is provided close to the rear edge portion 112d.

The area of the rear positive-pressure surface 112 is slightly smaller than that of the rear positive-pressure surface 12 in the magnetic head device 1 of the first embodiment shown in FIGS. 1 and 2, but the width thereof is 30% or more of the width of the front positive-pressure surface 11, and the area of the rear positive-pressure surface 112 is 20% or more of the area of the front positive-pressure surface 11.

A left projecting portion 112a projecting frontwardly is formed in the left end portion of the rear positive-pressure surface 112, and a right projecting portion 112b projecting frontwardly is formed in the right end portion. Accordingly, a front edge portion 112c of the rear positive-pressure surface 112 has a shape recessed rearward.

On the reference line O-O, a concave portion 114 formed in a concave shape rearward is formed in the rear positive-pressure surface 112. A facing space between a left inner wall 114a and a right inner wall 114b of the concave portion 114 becomes gradually smaller toward the trailing end surface 10d. A rear wall 114c of the concave portion 114 is located in the rear of the front edge portion 112c. On both sides of the concave portion 114, a pair of guide ribs 118, 118 extending frontwardly are provided. The guide ribs 118, 118 are linked from the rear positive-pressure surface 112 to the front positive-pressure surface 11, and the surfaces thereof are in the same plane as the rear positive-pressure surface 112 and the front positive-pressure surface 11. The guide ribs 118, 118 are formed in the same distance from the reference line O-O and a air guiding passage 120 is formed between both guide ribs 118, 118.

An inner width of the air guiding passage 120 is equal to the opening width (W1 shown in FIG. 2) of the concave portion 114. A lower surface of the air guiding passage 120 is in the same plane as the front step surface 21. The air guiding passage 120 is opened in the front edge portion 11a of the front positive-pressure surface 11 across the front positive-pressure surface 11.

In this magnetic head device 101, when the recording medium rotates with the opposed surface 10a of the slider 110 facing the recording medium D, a balance exists between a positive pressure applied to the front positive-pressure surface 11 and the rear positive-pressure surface 112 and a negative pressure generated in the negative-pressure generating regions 41, 42, 43, 44. A predetermined pitch angle is established and a floating distance from the recording medium D of the magnetic functional unit 2 is set. Further, a rolling posture of the slider 110 is stabilized by the left positive-pressure surface 15 and right positive-pressure surface 16.

The airflow flowing from the leading end surface 10c onto the surface of the front step surface 21 is guided from the central portion of the front edge portion 11a of the front positive-pressure surface 11 into an air guiding passage 120. Since the air guiding passage 120 with the same passage width is longitudinally formed frontward and rearward, the airflow is arranged in the air guiding passage 120, and is provided to the concave portion 114 located in the rear thereof. Since a distance between the left inner wall 114a and right inner wall 114b becomes gradually smaller rearward in the concave portion 114, the airflow moving in the air guiding passage 120 is concentrated on the reference line O-O of the rear positive-pressure surface 112.

For the reason, although a part in which the reference line O-O of the rear positive pressure 112 is located projected toward the recording medium D by the heat emitted by the magnetic functional unit 2, it can be suppressed such that the projecting part approaches the recording medium D by the local positive pressure generated. In addition, when the heat emitted by the magnetic functional unit 2 is low, and thus a part of the rear positive-pressure surface 112 does not project, a floating portion of the magnetic functional unit 2 from the recording medium D is properly set up, for example, in the range of 10 to 20 nm, by a balance of the above-mentioned local positive pressure, the entire positive pressure applied to the rear positive-pressure surface 112, the negative pressure generated in the negative-pressure generating region 41, 42, 43, 44, and particularly, the negative pressure generated in the left rear negative-pressure generating region 43, and the right rear negative-pressure generating region 44.

### EXAMPLES

### Example 1 and Example 2

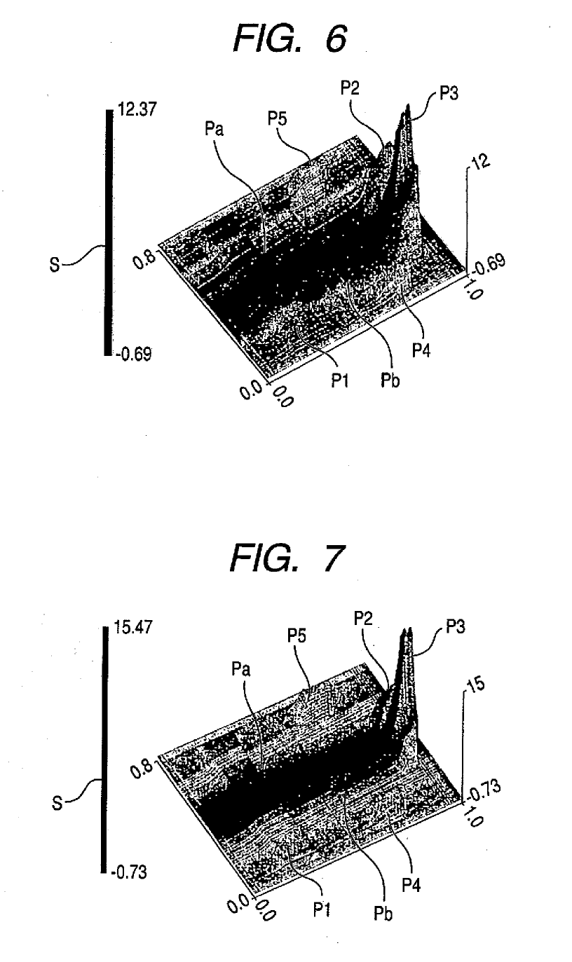

The magnetic head device 1 including the slider 10 that has the same configuration as FIGS. 1 and 2 was used in the “example 1”. When the opposed surface 10a of the magnetic head device 1 of the Example 1 faces the rotating recording medium D, the state of the positive pressure and negative pressure generated on the surfaces of the opposed surface is shown in a three-dimensional diagram in rig. 6. The magnetic head device 101 including the slider 110 that has the same configuration as FIG. 3 was used in the “Example 2”. When the opposed surface 10a of the slider 110 of the Example 2 facing the rotating recording medium D, a state of the positive pressure and negative pressure generated on the surfaces of the opposed surface is shown in a three-dimensional cubic diagram in FIG. 7.

FIGS. 6 and 7 show the result of simulation by using a computer analysis. In the simulation, the sliders in Example 1 and Example 2 were 0.85 mm of long sides (lengths of the side 10e and side 10f) and 0.70 mm of short sides (widths of the leading end surface 10c and the trailing end surface 10d). Further, level differences between the positive-pressure surfaces and the step surfaces were 0.15 μm and level differences between the positive-pressure surfaces and the bottom surfaces 31 were 1.00 μm. The pressing force (loading pressure) applied to the contact point 7a located on the pressing surface 10b of the slider were 24.5 mN and the revolution of the recording medium D is 4200 rpm. The air density is set up at 1 atm.

When a distance between the contact point 7a and the rotary center of the recording medium D is 16.2 mm, a position of the slider indicates MD shown in FIG. 10. A skew angle at this time was 0.44 deg. The skew angle is an angle formed by a tangent line of the recording medium D at the contact point 7a of the slider and the reference line O-O. In FIG. 10, a clockwise angle from the tangent line is positive and an anti-clockwise angle from the tangent line is negative.

When a distance between the contact point 7a and the rotary center of the recording medium D is 10.8 mm, a position of the slider indicates ID shown in FIG. 10. A skew angle at this time was −13.7 deg. When a distance between the contact point 7a and the rotary center of the recording medium D is 21.7 mm, a position of the slider indicates OD shown in FIG. 10. A skew angle at this time was 10.7 deg.

FIG. 6 is a result of a simulation when the slider 10 of Example 1 is located in the MD and a part that has the magnetic functional unit 2 does not locally project, that is, the magnetic functional unit 2 does not emit heat. Similarly, FIG. 7 is a result of a simulation when the slider 110 of Example 2 is located in the MD and a part that has the magnetic functional unit 2 does not locally project, that is, the magnetic functional unit 2 does not emit heat.

In FIGS. 6 and 7, a positive pressure applied to the front positive-pressure surface is indicated by P1, a positive pressure applied to the rear positive-pressure surface is indicated by P2, a high local positive pressure generated on the rear positive-pressure surface and the reference line O-O is indicated by P3, a positive pressure applied to the left positive-pressure surface is indicated by P4, and a positive pressure applied to the right positive-pressure surface is indicated by P5. Further, a negative pressure generated in the left front negative-pressure generating region and the right front negative-pressure generating region is indicated by Pa, and a negative pressure generated in the left rear negative-pressure generating region and the right rear negative-pressure generating region is indicated by Pb.

In FIGS. 6 and 7, a scale S shown left indicates the magnitude of the local positive pressure P3. The unit of the scale is atm (atmosphere) and 1 atm indicates “0”. Accordingly, in Example 1, as shown in FIG. 6, magnitude of the local positive pressure P3 is 13.37 atm and in Example 2, as shown in FIG. 7, the magnitude of the local positive pressure P3 is 16.47.

### Comparative Example 1 and Comparative Example 2

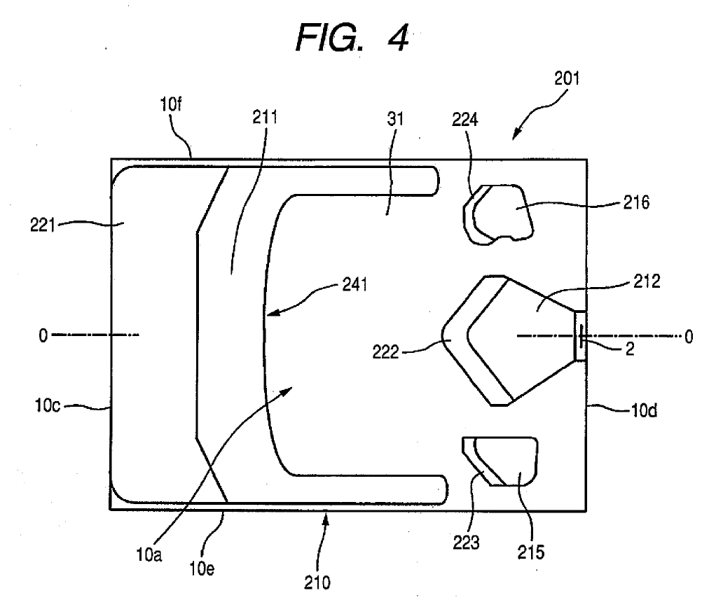

FIG. 4 is a plan view that illustrates a slider 210 of a magnetic head device 201 in Comparative Example 1 as viewed from an opposed surface 10a. In the magnetic head device 201 of Comparative Example 1, patterns of a positive-pressure surface in the opposed surface 10a of the slider 210 and a step surface are different from those of Example 1 and Example 2, but conditions are the same as Example 1 and Example 2 other than difference in the patterns.

In the opposed surface of the slider 210, a front positive-pressure surface 211 and a front step surface 221 are formed in the leading side, a rear positive-pressure surface 212 and a rear step surface 222 are formed in the trailing side, and a magnetic functional unit 2 is in the rear of the rear positive-pressure surface 212 and is close to the rear positive-pressure surface 212. A left positive-pressure surface 215 and a left step surface 223 are formed in the left of the rear positive-pressure surface 212, and a right positive-pressure surface 216 and right step surface 224 are formed in the left of the rear positive-pressure surface 212.

A region other than the positive-pressure surface and the step surface is a bottom surface 31. A negative-pressure generating region 241 is provided in the just rear of the front positive-pressure surface 211.

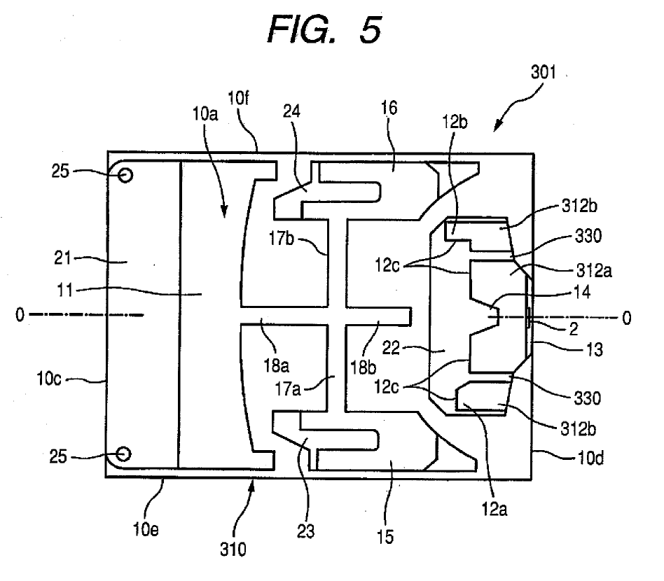

FIG. 5 is a plan view that illustrates a slider 310 of a magnetic head device 301 of Comparative Example 2 as viewed from an opposed surface 10a.

A pattern provided on the opposed surface 10a of the slider 310 is substantially equal to that of the magnetic head device 1 of Example 1 shown in FIG. 2. The only difference is that the rear positive-pressure surface 12 in Comparative Example 2 is divided into three parts and the others are equal to Example 1. As shown in FIG. 5, in Comparative Example 2, a positive-pressure surface that has the same shape as the rear positive-pressure surface of Example 1 is divided into three parts by grooves 330, 330. As a result, a central rear positive-pressure surface 312a and both side rear positive-pressure surface 312b, 312b are formed in the trailing side. In the central rear positive-pressure surface 312a, similar to Example 1, a concave portion 14 is formed.

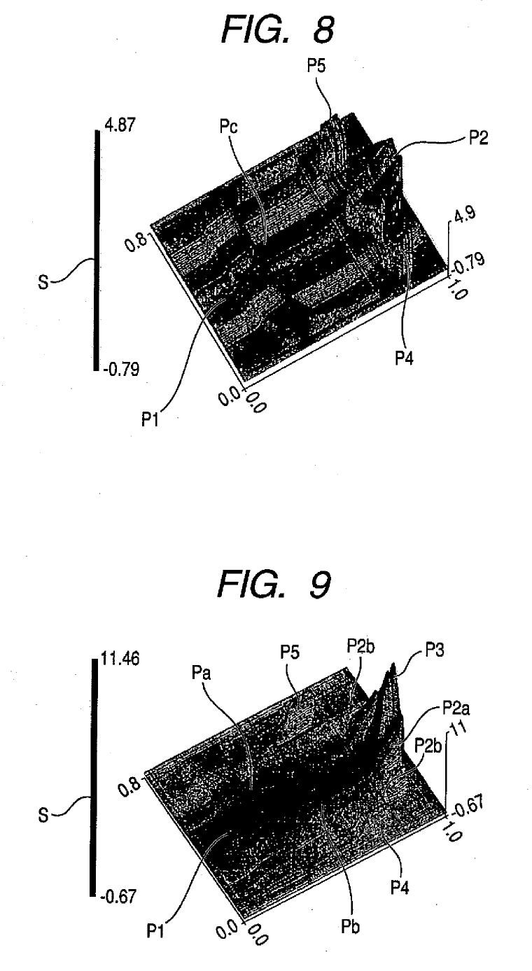

FIG. 8 is a result of a simulation when the magnetic head device 201 of Comparative Example 1 is located in the MD and a part that has the magnetic functional unit 2 does not locally project, that is, the magnetic functional unit 2 does not emit heat. Similarly, FIG. 9 is a result of a simulation when the magnetic head device 301 of Comparative Example 2 is located in the MD and a part that has the magnetic functional unit 2 does not locally project, that is, the magnetic functional unit 2 does not emit heat.

In FIG. 8, a positive pressure applied to the front positive-pressure surface 211 of Comparative Example 1 is indicated by P1, a positive pressure applied to the rear positive-pressure surface 212 is indicated by P2, a positive pressure applied to the left positive-pressure surface 215 is indicated by P4, a positive pressure applied to the right positive-pressure surface is indicated by P5, and a negative pressure generated in the negative-pressure generating region 241 is indicated by Pc. In Comparative Example 1, the maximum of the positive pressure applied to the rear positive-pressure surface 212 is 5.87 atm.

In the FIG. 9, a positive pressure applied to the central rear positive-pressure surface 312a of Comparative Example 2 indicates P2a, positive pressures applied to both side rear positive-pressure surfaces 312b, 312b is indicated by P2b, P2b, and in the concave portion 14, a local positive pressure high applied to the rear positive-pressure surface 312a is indicated by P3. The others are the same as the pressure-distributed state of Example 1 shown in FIG. 6.

In Comparative Example 2 shown in FIG. 9, since the rear positive-pressure surface is divided into three parts, a positive pressure on the whole rear positive-pressure surface decrease and thus a floating posture of the slider 310 is unstable. In Comparative Example 2, as shown in FIG. 5, a left projecting portion 12a and a right projecting portion 12b are provided on both side rear positive-pressure surfaces 312b, 312b and the front edge portion 12c is recessed toward the trailing side. However, since the rear positive-pressure surface is divided into three parts, air concentrated by a recessed-shaped front edge portion 12c flows out from the grooves 330, 330 rearward and thus the airflow concentrated in the concave portion 14 decreases. Consequently, the local positive pressure P3 is lower than that of Example 1. As shown in FIG. 9, the local positive pressure of Comparative Example 2 is 12.46 atm.

Simulation Assuming PTP Phenomenon

In Example 1, Example 2, Comparative Example 1, and Comparative Example 2, floating distances were obtained in the MD, ID, and OD by the conditions described in Example 1. In the uppermost column of following Table 1, when the projecting portion did not exist on the opposed surface of the slider of the magnetic head device due to the thermal expansion, “at normal temperature” (unit “nm”) indicates the floating distances in the vicinity of the intersection point of the trailing end surface with the reference line O-O.

Next, in the head devices of Example 1, Example 2, Comparative Example 1, and Comparative Example 2, when the vicinity of the intersection point of the trailing end surface of the slider with the reference line O-O was locally projected toward the recording medium by 5 nm, floating distances of the vicinity thereof were obtained in the MD, ID, and OD. In the middle column of Table 1, “with projection” indicates the floating distances (nm).

In the lowermost column of Table 1, “decrease in floating distance” (unit “nm”) indicates differences between “at normal temperature” and “with projection”.

It can be shown from Table 1 that the decrease in floating distance is suppressed in Example 1 and Example 2 when the vicinity of the intersection point of the trailing end surface with the reference line O-O was projected by 5 nm.

TABLE 1

| | | | | Comparative | Comparative |
|---|---|---|---|---|---|
| Floating distance | | Example 1 | Example 2 | Example 1 | Example 2 |
| At normal | ID | 13.4 | 13.9 | 15.1 | 12.2 |
| temperature | M | 14.0 | 15.4 | 16.4 | 14.4 |
| (nm) | D | | | | |
| | O | 13.6 | 14.3 | 17.1 | 15.8 |
| | D | | | | |
| With projection | ID | 8.90 | 9.47 | 10.2 | 7.64 |
| (nm) | M | 9.63 | 11.2 | 11.5 | 9.81 |
| | D | | | | |
| | O | 9.21 | 10.1 | 12.4 | 11.2 |
| | D | | | | |
| Decrease in | ID | 4.50 | 4.43 | 4.90 | 4.56 |
| floating | M | 4.37 | 4.20 | 4.90 | 4.59 |
| distance | D | | | | |
| (nm) | O | 4.39 | 4.20 | 4.70 | 4.60 |
| | D | | | | |

What is claimed is:

1. A magnetic head device comprising:
a slider that has an opposed surface facing a recording medium and a pressing surface on which a pressing force is applied toward the recording medium; and
a magnetic functional unit which is disposed in a trailing side of the slider so as to magnetically record data,
wherein a front positive-pressure surface located in a leading side, and a rear positive-pressure surface located in the trailing side, are disposed in the opposed surface of the slider,
wherein the magnetic functional unit is located in the rear positive-pressure surface or at a position closer to the trailing side than the rear positive-pressure surface, and close to the rear edge portion of the rear positive pressure surface, and
wherein projecting portions extending to the leading side are formed on both left and right sides of the rear positive-pressure surface, the front edge portion of the rear positive-pressure surface has a shape recessed toward the trailing side, and a concave portion is formed from the front edge portion toward the magnetic functional unit

2. A magnetic head device comprising:
a slider that has an opposed surface facing a recording medium., and a pressing surface on which a pressing force is applied toward the recording medium; and
a magnetic functional unit which is disposed in a trailing side of the slider so as to magnetically record data,
wherein a front positive-pressure surface located in the leading side and a rear positive-pressure surface located in a trailing side, are disposed in the opposed surface of the slider,
wherein the magnetic functional unit is located in the rear positive-pressure surface or at a position closer to the trailing side than the rear positive-pressure surface, and close to the rear edge surface of the rear positive pressure portion, and
wherein a concave portion is formed from the leading front edge portion of the rear positive-pressure surface toward the magnetic functional unit, a pair of guide ribs extending from the front edge portion to the leading side are formed on both sides of the concave portion, and an air guiding passage guiding air into the concave portion is formed between both guide ribs.

3. The magnetic head device according to claim 2, wherein the both guide ribs are continuously formed from the front positive-pressure surface to the rear positive-pressure surface, and the air guiding passage is open in the front edge portion of the front positive-pressure surface close to the leading side.

4. The magnetic head device according to claim 1, wherein the width of the concave portion becomes gradually smaller toward the trailing side.

5. The magnetic head device according to claim 1, wherein the width of the front positive-pressure surface is in the range of 30% to 100% of the width of the front positive-pressure surface.

6. The magnetic head device according to claim 1, wherein the area of the rear positive-pressure surface is in the range of 20% to 80% of that of the front positive-pressure surface.

7. The magnetic head device according to claim 1, wherein when an imaginary line extending parallel to the side surface of the slider through the center of the magnetic functional unit is used as a reference line, a central line equally dividing the width of the concave portion into two is matched with the reference line.
